(19) United States
(12) Patent Application Publication
(10) Pub. No.: US 2024/0323035 A1
(43) Pub. Date: Sep. 26, 2024

(54) METHOD FOR COLLECTING AND MANAGING VEHICLE-RECORDED DATA

(71) Applicants: Hyundai Motor Company, Seoul (KR); Kia Corporation, Seoul (KR)

(72) Inventors: Jung Hei Ryu, Hwaseong-si (KR); Seung Wook Park, Yongin-si (KR); Wha Pyeong Lim, Seongnam-si (KR)

(21) Appl. No.: 18/734,252

(22) Filed: Jun. 5, 2024

Related U.S. Application Data
(63) Continuation-in-part of application No. 18/309,928, filed on May 1, 2023.
Application No. 18/309,928 is a continuation of application No. 16/738,183, filed on Jan. 9, 2020, now Pat. No. 11,677,568.

(30) Foreign Application Priority Data
Jan. 9, 2019 (KR) 10-2019-0002568

(51) Int. Cl. H04L 9/32; B60R 11/00; B60R 21/013; G06F 16/22; G06F 16/29

(52) U.S. Cl. CPC H04L 9/3268; B60R 11/00; B60R 21/013; G06F 16/22; G06F 16/29

(57) ABSTRACT

A system and a method for collecting and managing vehicle-recorded data can be performed by one or more computing systems. A vehicle may transmit a first message containing a first certificate and vehicle-recorded data to a first database server associated with a first database so as to store the vehicle-recorded data anonymously in the first database. The first certificate is one of a plurality of short-term certificates assigned to the vehicle and enables an anonymization of the vehicle. The vehicle may transmit a second message containing the first certificate and a second certificate to a second database server associated with a second database so as to store an association of the first certificate with the vehicle in the second database. The second certificate is a long-term certificate assigned to the vehicle and enables an identification of the vehicle.

### CROSS-REFERENCE TO RELATED APPLICATIONS

This application is a continuation-in-part of U.S. patent application Ser. No. 18/309,928, filed on May 1, 2023, which is a continuation of U.S. patent application Ser. No. 16/738,183, filed on Jan. 9, 2020, now U.S. Pat. No. 11,677,568, issued on Jun. 13, 2023, which claims the benefit of Korean Patent Application No. 10-2019-0002568, filed on Jan. 9, 2019, which applications are hereby incorporated herein by reference.

This application is related to U.S. patent application Ser. No. 16/738,209 (published as US 2020/018729), which claims priority to Korean Patent Application No. 10-2019-0002567, filed on Jan. 9, 2019, which applications are hereby incorporated herein by reference.

### TECHNICAL FIELD

Embodiments relate to a method and system for collecting and managing vehicle-recorded data of vehicles.

### BACKGROUND

The statements in this section merely provide background information related to the present disclosure and may not constitute prior art.

In general, an event data recorder (EDR) is configured to detect an accident or the like and store information about a driving state of a vehicle or an operation by a driver within a predetermined period from a time before the corresponding time to a time after the corresponding time. At least several parameters, including speed, seat belt status, and airbag inflation status, are stored such that they may be retrieved in a forensic investigation.

Meanwhile, with more vehicles being given the benefit of ADAS (Advanced Driver Assistance Systems) or ADS (autonomous driving system), traffic accidents are becoming more attributed to vehicles than to the drivers. For proper clarification of causes of an accident, there is a growing demand to collect data in addition to the data recorded by the existing Event Data Recorder (EDR), such as additional information regarding the operational status of the ADAS or the ADS. Recently, DSSAD (Data Storage System for Automated Driving) was introduced, which records and stores vehicle data for significant interactions between the driver and the ADS to identify who or what was controlling the vehicle at a given time or whether the driver was requested to take over the control of the vehicle.

The forensic investigation is generally performed by reading data through an OBD-II port or by physically extracting the data memory of the EDR or DSSAD. The data in the EDR may be damaged or altered due to incorrect reading techniques, or may be maliciously manipulated or deleted after being stored. Accordingly, it may be difficult to perfectly ensure integrity of the stored data.

In investigating the situation surrounding a traffic event (e.g., a traffic accident), investigators from government agencies or private organizations, such as insurance companies and car manufacturers, identify and track specific data sources (e.g., vehicles involved in an accident), and then independently collect the information they need from each data source to identify the causes of the accident, defects, exacerbations, and mitigations. Such information may include data in the EDR or the DSSAD. Unfortunately, collecting information in this manner may take lots of time and effort. Moreover, some data sources may be unidentified, may be no longer available at the time they are identified, or may have already been deleted. Therefore, there is a need for a system and related method for collecting and storing data that is in an EDR or a DSSAD of a vehicle so as to automatically identify a data source having data relating to a traffic event and acquire such data in a timely manner.

### SUMMARY

A cloud storage or remote server may be a secure space that may prevent unauthorized access and prevent data corruption. That is, in order to maintain the integrity of vehicle-recorded data (e.g., data recorded in the EDR or the DSSAD), it may be considered to store the vehicle-recorded data in a reliable cloud storage. However, to store the vehicle-recorded data in the cloud storage, measures to protect the privacy of individuals needs to be considered as well. In this context, the present disclosure proposes a cloud-based vehicle-recorded data management system that may protect the privacy of individuals.

Embodiments relate to a method and system for collecting and managing the vehicle-recorded data of a vehicle or multiple vehicles. Embodiments can relate to a method and system for managing the vehicle-recorded data in a cloud-based manner.

In accordance with one aspect of the present invention, a method includes transmitting, by a vehicle, a first message containing a first certificate and vehicle record data to a first database server associated with a first database so as to store the vehicle record data anonymously in the first database. The first certificate is one of a plurality of short-term certificates assigned to the vehicle and enables an anonymization of the vehicle. The method further includes transmitting, by the vehicle, a second message containing the first certificate and a second certificate to a second database server associated with a second database so as to store an association of the first certificate with the vehicle in the second database. The second certificate is a long-term certificate assigned to the vehicle and enables an identification of the vehicle. Unlike the long-term certificate, the short term certificates do not contain information that may be easily associated with the vehicle (or an owner thereof).

Embodiments of the method may further include one or more of the following features.

In some embodiments, the first message may further contain an electronic signature to be verified with a public key related to the first certificate, and the second message may further contain an electronic signature to be verified with a public key related to the second certificate.

In some embodiments, the first message may further contain a geographical location at which the vehicle records the vehicle record data.

In some embodiments, the vehicle record data may include event data having been recorded by an event data recorder equipped in the vehicle. In some embodiments, the vehicle record data may include interaction data representing timestamped interactions that have occurred between an autonomous driving system of the vehicle and a driver of the vehicle. In some embodiments, the vehicle record data may include both the event data and interaction data.

In some embodiments, the first database server and the second database server may be under managed by different operators. For example, the first database server may be managed by the vehicle manufacturer, and the second server may be managed by a service provider different from the vehicle manufacturer.

In accordance with another aspect of the present disclosure, a telecommunication device equipped in a vehicle can be used for collecting and managing vehicle-recorded data. The device includes one or more processors, memory operatively coupled to the one or more processors, and a wireless transceiver configured to communicate wirelessly via at least one communication network. The processor may be configured to transmit a first message containing a first certificate and vehicle record data to a first database server associated with a first database so as to store the vehicle record data anonymously in the first database. The first certificate is one of a plurality of short-term certificates assigned to the vehicle and enables an anonymization of the vehicle. The processor may be further configured to transmit a second message containing the first certificate and a second certificate to a second database server associated with a second database so as to store an association of the first certificate with the vehicle in the second database. The second certificate is a long-term certificate assigned to the vehicle and enables an identification of the vehicle.

In accordance with another aspect of the present disclosure, provided is a non-transitory computer-readable medium storing computer-readable instructions for a telecommunication device equipped in a vehicle. The computer-readable instructions, when executed by a processor of the telecommunication device, cause the telecommunication device to transmit a first message containing a first certificate and vehicle record data to a first database server associated with a first database so as to store the vehicle record data anonymously in the first database, and transmit a second message containing the first certificate and a second certificate to a second database server associated with a second database so as to store an association of the first certificate with the vehicle in the second database.

According to the proposed method and system, vehicle-recorded data (e.g., EDR data or DSSAD data) about an event/interaction of interest may be easily obtained in a timely manner by searching a database on a network. In addition, the vehicle-recorded data stored in a storage on a reliable network may be useful for forensic investigations where the integrity of event data is required.

Further, according to the proposed method and system, the collected vehicle-recorded data is stored in a database in association with a short-term certificate (or an identifier extracted therefrom). The short-term certificate does not contain information that may be easily associated with a vehicle (or its owner), and therefore use of a short-term certificate anonymizes the vehicle-recorded data in the database. However, the pseudonym certificate is managed in a separate database in association with a long-term certificate that may identify a relevant vehicle such that an authorized person may selectively acquire vehicle-recorded data generated by a specific vehicle. No database stores vehicle-recorded data and information for identifying the vehicle associated therewith. Thus, protection of privacy may be further enhanced.

### BRIEF DESCRIPTION OF THE DRAWINGS

FIG. 1 is a diagram illustrating an entire system for storing and managing vehicle-recorded data in a cloud-based manner according to an embodiment of the present disclosure.

FIG. 2A is a flowchart illustrating an event data collection process of the system shown in FIG. 1.

FIG. 2B is a flowcharts illustrating an interaction data collection process of the system shown in FIG. 1

FIG. 3 is a diagram illustrating an entire system for storing and managing vehicle-recorded data in a cloud-based manner according to another embodiment of the present disclosure.

FIG. 4A is a flowchart illustrating an event data collection process of the system shown in FIG. 3.

FIG. 4B is a flowchart illustrating an interaction data collection process of the system shown in FIG. 3.

FIG. 5 is a flowchart illustrating a process of providing anonymized event data by the system illustrated in FIG. 1 or 3.

FIG. 6 is a flowchart illustrating a process of providing vehicle-recorded data related to a specific vehicle by the system illustrated in FIG. 1 or 3.

### DETAILED DESCRIPTION OF ILLUSTRATIVE EMBODIMENTS

Hereinafter, some embodiments of the present disclosure will be described in detail with reference to the accompanying drawings. It should be noted that, in adding reference numerals to the constituent elements in the respective drawings, like reference numerals designate like elements, although the elements are shown in different drawings. Further, in the following description of the present disclosure, a detailed description of known functions and configurations incorporated herein will be omitted when it may make the subject matter of the present disclosure rather unclear.

Additionally, various terms such as first, second, A, B, (a), (b), etc., are used solely for the purpose of differentiating one component from the other but neither imply nor suggest the substances, order or sequence of the components. Throughout this specification, when a part “includes” or “comprises” a component, the part may further include other components, and such other components are not excluded unless there is a particular description contrary thereto. Terms such as “unit,” “module,” and the like refer to units for processing at least one function or operation, which may be implemented by hardware, software, or a combination thereof.

In order to meet the authentication and privacy requirements in V2X communication, many studies that support Public Key Infrastructure (PKI) have been conducted. One approach of particular interest relies on pseudonym certificates. Unlike conventional certificates, pseudonym certificates do not contain information that may be easily associated with the owner of a vehicle and may only be identified by the pseudonym. A pseudonym is included in the pseudonym certificate as a ‘subject identifier’. Thus, the pseudonym certificate may be used to sign messages broadcast to other vehicles without compromising the owner's privacy. Multiple pseudonym certificates are issued for one vehicle, and the issuing authority of the pseudonym certificate does not know the vehicle for which the pseudonym certificates are issued. Due to its short validity period, a pseudonym certificate is also called a short-term certificate. A long-term certificate that has a long validity period associated with the life of the vehicle is provided for situations in which the vehicle should be identified (e.g., verifying the authority to obtain a new pseudonym certificate).

According to at least some embodiments of the disclosure, vehicle-recorded data generated in each vehicle is stored and managed in a database on a network. To protect the privacy of individuals, the collected vehicle-recorded data is anonymized with pseudonym certificates (or pseudonyms extracted therefrom). However, the pseudonym certificate is managed in a separate database in association with a long-term certificate for identifying a unique identifier of the vehicle, such that an authorized person may selectively acquire vehicle-recorded data generated by a specific vehicle.

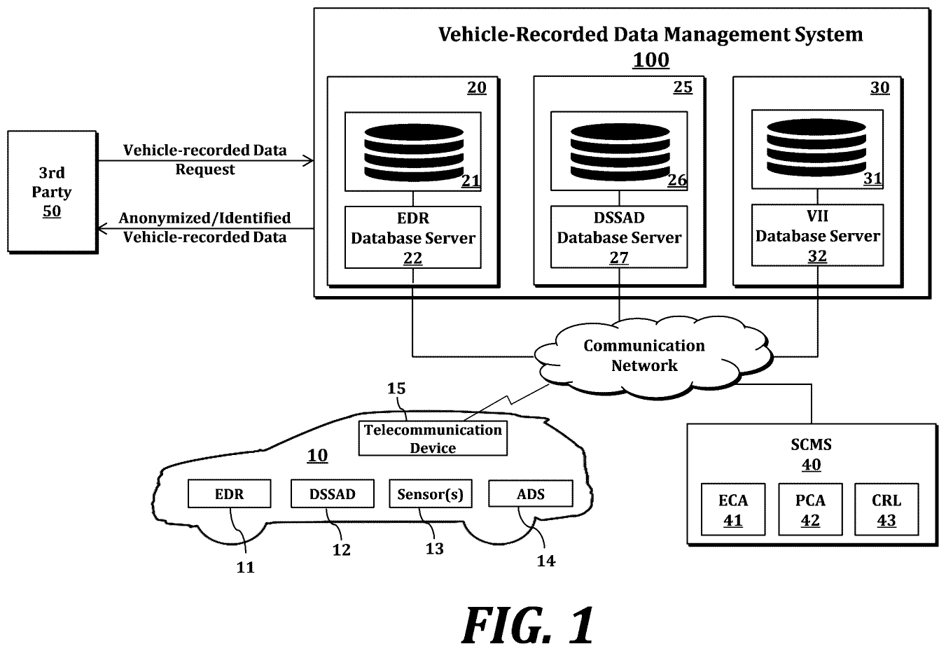

FIG. 1 is a conceptual diagram illustrating an example of a centralized system for collecting and managing vehicle-recorded data from vehicles, according to one embodiment of the present disclosure.

A system includes an in-vehicle data recording system 10 provided in a vehicle, and a vehicle-recorded data management system 100 implemented as server(s) on a network. The server(s) implementing the vehicle-recorded data management system 100 may be server(s) operated by a vehicle manufacturer or server(s) operated by an operator who is independent of the vehicle manufacturers, or may include a combination thereof.

A vehicle is configured to operate fully or partially in an autonomous driving mode and may therefore be referred to as an “autonomous driving vehicle.” For example, an autonomous driving system 14 may receive information from a sensor system 13 and execute, in an automated manner, one or more control processes based on the received information (for example, setting steering to avoid detected obstacles).

A vehicle may be fully autonomous or partially autonomous. In a partially autonomous vehicle, some functions may be temporarily or continuously controlled manually by a driver. Further, the fully autonomous vehicle may be configured to be switchable between a fully manual operating mode and a partially autonomous operating and/or fully autonomous operating mode.

The in-vehicle data recording system 10 may be configured to generate, record, or store various types of data related to vehicle operation or driver behavior. The in-vehicle data recording system 10 includes two types of data recorders: an Event Data Recorder (EDR) 11 and a Data Storage System for Automated Driving Vehicles (DSSAD) 12. They record vehicle-recorded data for different purposes.

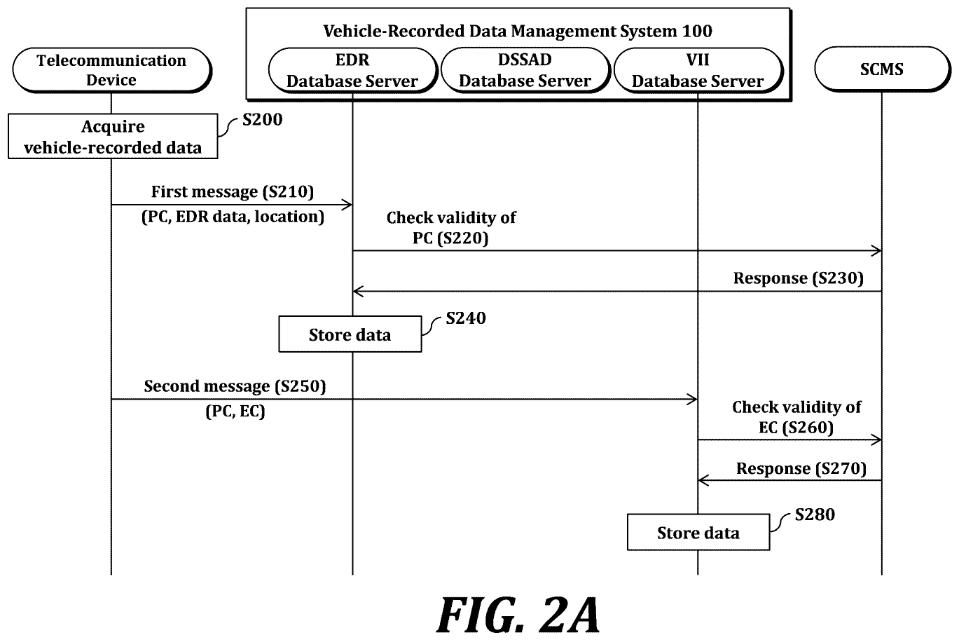

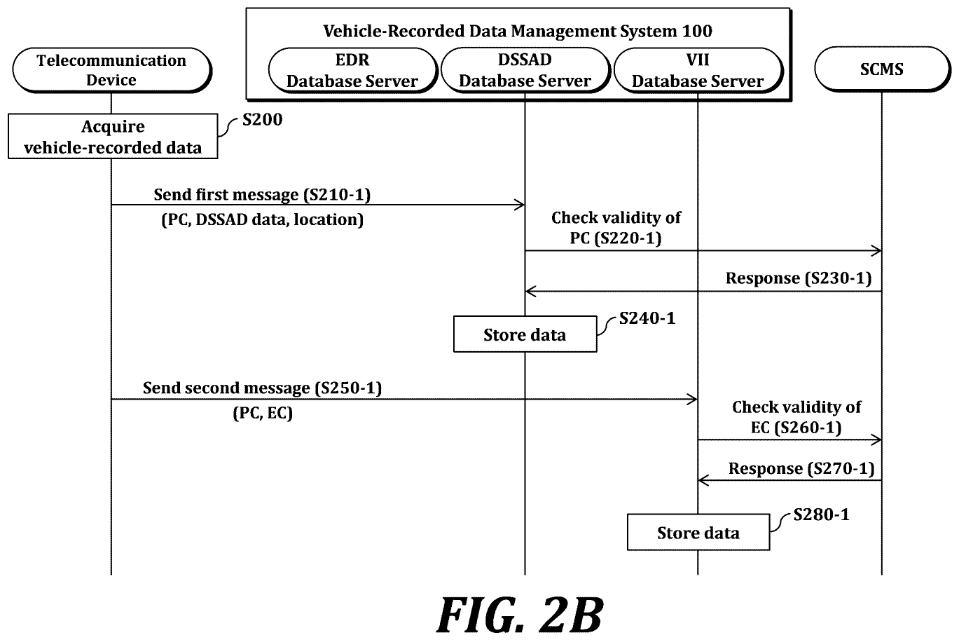

The purpose of the EDR 11 is to store vehicle information for specific events such as a crash accident or an airbag deployment. Data from the EDR 11 is used for collision analysis and reconstruction. The purpose of the DSSAD 12 is to record all predefined interactions between a driver and an autonomous driving system. As illustrated in FIG. 2, EDR 11 records or stores relevant data when an event such as the crash accident occurs, whereas DSSAD 12 records or stores interactions between vehicle and driver while driving. Data from the DSSAD 12, typically stored in timestamp format, is used to identify a subject who was controlling a vehicle (either the driver or the autonomous driving system) at a particular time point. The data of the EDR 11 and the data of the DSSAD 12 are used complementary to each other in forensic investigations, and in particular, the data of the DSSAD 12 is useful for identifying a subject who was controlling the vehicle at the time of collision.

The EDR 11 may be configured to receive data from various sensors and/or electronic control units (ECUs) mounted on the vehicle. The EDR 11 has a volatile memory of the EDR 11 that has data for a certain period temporarily stored while being continuously updated. The EDR 11 may be responsive to a detection of the occurrence of one or more predefined events for recording, into an internal non-volatile memory, the data that was stored in the volatile memory within a predetermined time before and after the detection. Such an event may in particular be a traffic collision. A traffic collision may be detected, for example, by the triggering deployment of an irreversible safety device such as an airbag or seat belt preloading device. A traffic collision may also be detected at the occurrence of acceleration/deceleration exceeding a predefined threshold (e.g., a speed change of 8 km/h or higher within about 150 ms). The predefined event(s) may further include a malfunction of the main function of the vehicle.

The EDR 11 may be configured to receive trigger signal(s) informing of the occurrence of an event from the electronic control unit(s), such as, for example, an airbag control unit (ACU). The EDR 11 may be accessible to values measured by at least one or more sensors 13. At least one sensor 13 may be configured to detect vehicle speed/acceleration/deceleration/travel distance/geographical position, and the like. The EDR 11 may be included as a functional module in the airbag control unit (ACU).

The data recorded by the EDR 11 may be data suitable for analyzing traffic collisions, such as, for example, data of vehicle dynamics, a driver's behavior, and an operating state of a vehicle safety system. The EDR 11 may be configured to transmit recorded data (hereinafter referred to as “event data” or “EDR data”) to a telecommunication device 15 so as to be transmitted to the vehicle-recorded data management system 100. In an exemplary embodiment, the EDR 11 may be configured to be provided to the telecommunication device 15 immediately after storage of event data, such that related event data may be transmitted to the vehicle-recorded data management system 100 without delay after an event has occurred.

The autonomous driving system (ADS) 14 may be configured to generate interaction signals indicative of interactions between a driver and the autonomous driving system 14. These interaction signals may include a signal indicating whether one or more autonomous driving functions are currently active. For example, the autonomous driving system 14 may generate a signal indicating whether a specific feature such as an adaptive cruise control (ACC) function or an automated lane keeping system (ALKS) is currently active. As another example, the autonomous driving system 14 may generate a signal indicating whether driving of a vehicle is currently being controlled fully automatically rather than manually. In addition, these interaction signals may further include signals indicating a transition demand indicating that control of the driving task to a driver needs to be taken over, and signals indicating that control of the driving task to the driver has been taken over. The autonomous driving system 14 may provide interaction signals to the DSSAD 12 via a data bus (for example, CAN bus, Ethernet bus, etc.).

The DSSAD 12 may store interaction data representing interaction between a driver and the autonomous driving system in an internal non-volatile memory based on the interaction signals received from the autonomous driving system 14. The DSSAD 12 is installed on a vehicle equipped with a highly-automated driving system (for example, SAE level 3, 4, 5 classification), and is a data storage system that aims to clarify “subjects requested to drive” and “subjects who actually drove.” During the transition procedure (that is, after the transition demand is issued and until a driver actually takes over control), the “subject requested to drive” and the “subject who actually drove” may be different from each other.

Interaction data (hereinafter, may also be referred to as “DSSAD data”) may include time-stamped data elements representing specific interactions, such as, for example, changing the state (switched off, activated, transition demand, override) of the autonomous driving system, starting and ending Minimal Risk Maneuver (MRM) by the autonomous driving system, and taking over control of a driving task to a driver. In some embodiments, the interactions may further include an occurrence of an event that triggers recording of the EDR 11 and an occurrence of a minor event that does not trigger recording of the EDR 11.

The DSSAD 12 may provide the stored interaction data to the telecommunication device 15 (in accordance with a predefined schedule or in response to a request of the telecommunication device 15) so as to be transmitted to a vehicle-recorded data management system 100.

In some other embodiments, the interaction data may be periodically uploaded to the vehicle-recorded data management system 100. For example, the DSSAD 12 may be scheduled to perform an upload procedure of the interaction data every 6 hours or 12 hours, or every day or every week. When ignition of a vehicle enters an ON state, the DSSAD 12 may determine whether an upload period has elapsed from a time point of the last upload. When it is determined that the upload period has elapsed, the DSSAD 12 may initiate an upload procedure. In some other embodiments, the DSSAD 12 may be configured to initiate an upload procedure for transmitting interaction data to the vehicle-recorded data management system 100 whenever the ignition of the vehicle enters an ON state. In yet some other embodiments, when the percentage of empty storage space in the internal storage of the DSSAD 12 reaches a threshold value, the DSSAD 12 may be configured to perform an upload procedure for transmitting the interaction data to the vehicle-recorded data management system 100. As such, unlike event data (i.e., EDR data), interaction data accumulated over a considerable period of time is uploaded instead of being uploaded to the vehicle-recorded data management system 100 whenever an interaction occurs.

The telecommunication device 15 may be a wired or wireless telecommunication device that connects the vehicle's internal network to an external communication network. The telecommunication device 15 may be, for example, a telematics unit (TMU), or a wired/wireless dongle plugged into an OBD-II port. The telecommunication device 15 may include, for example, a wireless transceiver capable of cellular communication such as GSM/WCDMA/LTE/5G or wireless short-range communication such as WLAN, c-V2X, WAVE, DSRC and Bluetooth.

The telecommunication device 15 may hold or access one long-term certificate and multiple short-term certificates used for security of the V2X communication. The telecommunication device 15 may change a short-term certificate to be used, for example, every 5 minutes. As described below, the long-term certificate and the multiple short-term certificates may be an enrollment certificates and multiple pseudonym certificates issued by a Security Credentials Management System (SCMS) 40. In the following description, the terms “pseudonym certificate” and “short-term certificate” may be used interchangeably, and the terms “long-term certificate” and “registration certificate” may be used interchangeably.

The telecommunication device 15 may transmit a first message containing vehicle-recorded data and a short-term certificate to an EDR database server 22 or a DSSAD database server 27 over a communication network. The first message may be anonymized using the short-term certificate. The first message may contain vehicle-recorded data signed with a related signature key (i.e., private key) of the short-term certificate.

For example, upon receiving the event data from the EDR 11, the telecommunication device 15 may transmit an event report message containing the event data and a short-term certificate to the EDR database server 22 over a communication network. For another example, upon receiving the DSSAD data from the DSSAD 12, the telecommunication device 15 may transmit an interaction report message containing the DSSAD data and a short-term certificate to the DSSAD database server 27 over a communication network.

Subsequent to the transmission of the first message, the telecommunication device 15 may also transmit a second message containing a long-term certificate and the short-term certificate (used in the first message) to a VII database server 32. The second message may contain a short-term certificate signed with a related signature key (i.e., private key) of the long-term certificate. Alternatively, the telecommunication device 15 may transmit the second message containing the short-term certificate and the long-term certificate before transmitting the first message.

The vehicle-recorded data management system 100 stores and manages vehicle-recorded data acquired from multiple vehicles. As mentioned above, in order to protect the privacy of individuals, the collected vehicle-recorded data is anonymized with a short-term certificate (or pseudonym extracted therefrom) and stored in the event database 21 or the interaction database 26. In order to selectively extract vehicle-recorded data generated by a specific vehicle, a pseudonym certificate used to identify the vehicle-recorded data is managed in a separate database (i.e., VII database 31) in association with a long-term certificate that enables unique identification of the related vehicle. The vehicle-recorded data and information for identifying a vehicle related thereto are not stored together in any database.

In this embodiment, subsystems 20, 25 for storing vehicle-recorded data (e.g., EDR data or DSSAD data) and a subsystem 30 for storing VII data for identifying a related vehicle are independently implemented in the vehicle-recorded data management system 100. The subsystems 20, 25 and 30 may be managed by different operators. These operators may cooperate with each other to provide storage/management/inquiry services for the vehicle-recorded data collected from multiple vehicles and to protect privacy. Alternatively, the subsystems 20, 25 and 30 may be managed independently by one operator. In some embodiments, the subsystem 30 for storing VII data may be managed by a vehicle manufacturer, and the subsystems 20, 25 for storing vehicle-recorded data may be managed by service provider different from the vehicle manufacturer

The subsystem 20 may include an event database 21 and an EDR database server 22 configured to manage the event database 21. The subsystem 25 for storing vehicle-recorded data may include an interaction database 26 and a DSSAD database server 27 configured to manage the interaction database 26.

The subsystem 30 may include a VII database 31 and a VII database server 32 configured to manage the VII database 31.

The EDR database server 22 may receive a first message containing event data as vehicle-recorded data from multiple vehicles. As described above, the first message may contain a pseudonym certificate, event data, and a location of event occurrence (i.e., a geographic location of the vehicle at the time of event occurrence). The first message may also contain an electronic signature generated using a private key associated with the short-term certificate for the “event data and/or location of event occurrence.” The EDR database server 22 may verify the signature contained in the first message with an associated public key of the short-term certificate. The EDR database server 22 may store the event data and the event occurrence location in the event database 21 in association with the short-term certificate (or a pseudonym extracted therefrom). That is, in the event database 21, event data may be identified by one of multiple pseudonyms assigned to a vehicle which is a source of the interaction data.

The DSSAD database server 27 may receive a first message containing interaction data as vehicle-recorded data from multiple vehicles. As described above, the first message may contain a pseudonym certificate, interaction data, and a location of interaction occurrence (i.e., a geographic location of the vehicle at the time of interaction occurrence). The first message may also contain an electronic signature generated using a private key associated with the short-term certificate for the “interaction data and/or location of interaction occurrence.” The DSSAD database server 27 may verify the signature contained in the first message with an associated public key of the short-term certificate. The DSSAD database server 27 may store the interaction data and the interaction occurrence location in the interaction database 26 in association with the short-term certificate (or a pseudonym extracted therefrom). That is, in the interaction database 26, interaction data may be identified by one of multiple pseudonyms assigned to a vehicle which is a source of the interaction data.

The VII database server 32 may receive a second message from multiple vehicles. As described above, the second message may contain a long-term certificate and the short-term certificate used in the first message. The second message may also contain an electronic signature for the short-term certificate generated using an associated private key of the long-term certificate. The VII database server 32 may verify the signature contained in the second message with an associated public key of the long-term certificate. The long-term certificate may be an explicit certificate that includes the associated public key. The VII database server 32 may associate the short-term certificate with the long-term certificate and store the same in the VII database 31. In other words, the VII database 31 may manage the association between a unique identifier of a vehicle (contained in the long-term certificate) and a pseudonym (contained in the short-term certificate) to enable identification of a specific vehicle corresponding to the pseudonym. The unique identifier of the vehicle may be, for example, a vehicle identification number (VIN), a MAC address of a wireless transceiver (included in the telecommunication device), or the like.

The vehicle-recorded data management system 100 may be associated with the SCMS 40, which is V2X security infrastructure. The SCMS 40 may include an Enrollment Certificate Authority (Enrollment CA or ECA) 41, a Pseudonym Certificate Authority (Pseudonym CA or PCA) 42, and a CRL management server 43 as functional components thereof.

The ECA 41 is an authority that issues an enrollment certificate associated with a unique identifier of each of vehicles. The ECA 41 generates a public key and a private key assigned to the unique identifier of a vehicle, and issues the enrollment certificate, which is a certificate for the public key and enables an identification of the vehicle, to the vehicle. This certificate is a long-term certificate that has a long validity period associated with the life of the vehicle. In addition, the ECA 41 makes a request to the Pseudonym CA for issuance of pseudonyms assigned to the unique identifier of the registered vehicle.

The PCA 42 is an authority that issues a pseudonym certificate. Upon receiving a pseudonym issuance request from the ECA 41, the PCA 42 generates multiple pseudonym certificates for the corresponding unique identifier and issues the same to the vehicle. Here, the pseudonym certificate may include a public key, a validity period of the public key, and a digital signature of the PCA 42. The pseudonym certificates are short-term certificates used for a very short period of time, and thus enable an anonymization of the vehicle.

The CRL management server 43 is an entity that generates and distributes a Certificate Revocation List (CRL).

Before inputting the vehicle-recorded data (i.e., the event data or the interaction data) contained in the first message into the event database 21 or the interaction database 26, the EDR database server 22 or the DSSAD database server 27 may check the CRL managed by the SCMS to check the validity of the short-term certificate contained in the first message. Upon determining that the short-term certificate is valid, the EDR database server 22 or the DSSAD database server 27 may input the event data or the interaction data contained in the received first message into the event database 21 or the interaction database 26. Similarly, the VII database server 32 may check the CRL managed by the SCMS 40 to check the validity of the long-term certificate contained in the second message. Upon determining that the long-term certificate is valid as a result of the checking, the VII database server 32 may associate the short-term certificate with the long-term certificate and store the same in the VII database 31. Alternatively, in order to internally check the validity of the short-term and long-term certificates, the vehicle-recorded data management system 100 may be configured to include a CRL management module (not shown) configured to separately store and manage a certificate revocation list (CRL) that is periodically distributed by the SCMS 40.

Investigators or researchers from various institutions may make a request to the vehicle-recorded data management system 100 for checking of the desired vehicle-recorded data. A third party 50 may be a user who wants to utilize anonymized vehicle-recorded data or identified vehicle-recorded data, for example, an insurance company or a government agency, a researcher, a vehicle manufacturer, a vehicle owner, or the like. In response to a query from the third party 50, the vehicle-recorded data management system 100 may cause the EDR database server 22 the DSSAD database server 27 and/or the VII database server 32 to extract vehicle-recorded data specific to the query of the third party from the event database 21, the interaction database 26 and/or VII database 31. The query may include at least one parameter related to an investigation range or criterion, such as an event/interaction location, an event/interaction date, an event/interaction time, the model of a vehicle involved, and a VIN.

As an example, upon receiving a request for vehicle-recorded data related with an event/interaction that has occurred in a specific area for a certain period of time from government investigators or researchers, the vehicle-recorded data management system 100 may cause the EDR database server 22 or the DSSAD database server 27 to search the event database 21 or interaction database 26 and extract related vehicle-recorded data. Since the vehicle-recorded data extracted from the event database 21 and the interaction database 26 are data anonymized with short-term certificates (or pseudonyms extracted therefrom), provision of the extracted vehicle-recorded data does not compromise the privacy of the owner of the vehicle which is a source of the vehicle-recorded data.

As another example, upon receiving a request for vehicle-recorded data related to a specific VIN from an investigator of an insurance company, the vehicle-recorded data management system 100 may search the VII database 31 for a long-term certificate corresponding to the VIN via the VII database server 32 and specify a short-term certificate (or a pseudonym extracted therefrom) associated with the long-term certificate. Then, the vehicle-recorded data management system 100 may cause the EDR database server 22 or the DSSAD database server 27 to search the event database 21 or the interaction database 26 to extract vehicle-recorded data associated with the specified pseudonym certificate (or pseudonym).

For further protection of the privacy of individuals, the VII database server 32 may further control access to data stored in the VII database 31 based on a preset access authorization policy. For example, the access authorization policy may only allow access by investigators or other users authorized by each vehicle owner unless otherwise authorized by court order, a search warrant and/or other applicable laws and regulations. In other words, the preset authorization policy may provide different levels of access for different users of the VII database 31. On the other hand, the EDR database server 22 and the DSSAD database server 27 managing the anonymized databases 21, 26 may use a less stringent access authorization policy than the VII database server 32. For example, the EDR database server 22 may use an access authorization policy that is based only on a billing system for third parties requesting anonymized event data.

In addition, a firewall may be used for the database servers 22, 27 and 32 or database encryption techniques may be applied to the databases 21, 26 and 31. In particular, to ensure secure management of the VII data, advanced security techniques may be adopted for the VII database server 32 and/or the VII database 31.

FIG. 2 is a flowchart illustrating an event data collection process of the system shown in FIG. 1. FIG. 2B is a flowcharts illustrating an interaction data collection process of the system shown in FIG. 1.

First, a vehicle telecommunication device (TMU) 15 acquires vehicle-recorded data from one or more modules, components, and programs including the EDR 11 and the DSSAD 12 (S200). For example, the telecommunication device (TMU) 15 may receive event data recorded before and after an event from the EDR 11 and collect information on the geographical location, date, and time of the event, an involved vehicle model, etc. For another example, the telecommunication device (TMU) 15 may receive interaction data from the DSSAD 12 and collect information on the geographical location, date, and time of the interaction, an involved vehicle model, etc.

The telecommunication device (TMU) 15 wirelessly transmits a first message containing the vehicle-recorded data and a short-term certificate to the EDR database server 22 or the DSSAD database server 27 on a network (S210, S210-1). As described above, the first message may contain a short-term certificate, vehicle-recorded data, and a geographic location. In addition, the first message may further contain an electronic signature generated using a private key related to the short-term certificate for the vehicle-recorded data and the geographical location.

Upon receiving the first message containing the event data as the vehicle-recorded data, the EDR database server 22 anonymizes the event data contained in the first message and inputs the event data into the event database 21 (S240, S240-1). For example, the EDR database server 22 may associate the event data and the geographical location (where the event occurred) with the short-term certificate of a corresponding vehicle and store the same in the event database 21. The EDR database server 22 may check the validity of the short-term certificate by querying the SCMS 40 for a CRL before storing the event data (S220 and S230).

In similarly, upon receiving the first message containing the interaction data as the vehicle-recorded data, the DSSAD database server 27 anonymizes the interaction data contained in the first message and inputs the interaction data into the interaction database 26 (S240-1). For example, the DSSAD database server 27 may associate the interaction data and the geographical location (where the interaction occurred) with the short-term certificate of a corresponding vehicle and store the same in the interaction database 26. The DSSAD database server 27 may check the validity of the short-term certificate by querying the SCMS 40 for a CRL before storing the interaction data (S220-1 and S230-1). In some embodiments, operations S220-1 to S230-1 for verifying the validity of the short-term certificate PC may be skipped.

The VII database server 32 receives, from the vehicle, a second message containing a long-term certificate and the short-term certificate, the short-term certificate was used for the electronic signature of the first message (S250, S250-1). The VII database server 32 may associate the short-term certificate with the long-term certificate and store the same in the VII database 31 (S280, S280-1). Before storing the short-term certificate, the VII database server 32 may check the validity of the long-term certificate by querying the SCMS 40 for the CRL (S260 to S270 and S260-1 to S270-1).

Unlike the examples illustrated in FIG. 2A and FIG. 2B, the telecommunication device 15 may transmit the second message containing the short-term certificate and the long-term certificate before transmitting the first message containing the vehicle-recorded data and the short-term certificate to the VII database server 32.

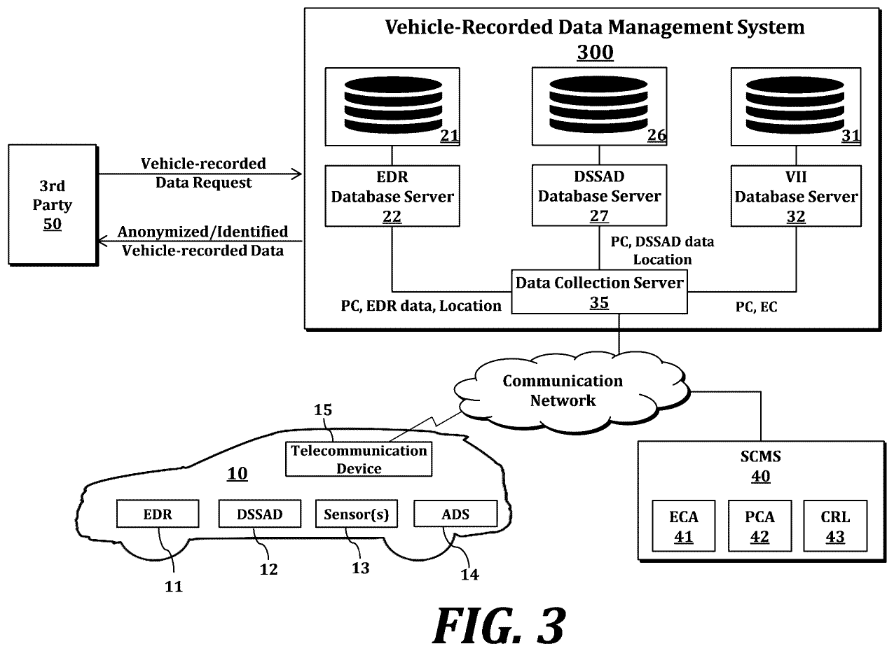

FIG. 3 is a diagram illustrating an entire system for storing and managing event data in a cloud-based manner according to another embodiment of the present disclosure.

Compared to the vehicle-recorded data management system 100 illustrated in FIG. 1, a vehicle-recorded data management system 300 illustrated in FIG. 3 further includes a data collection server 35.

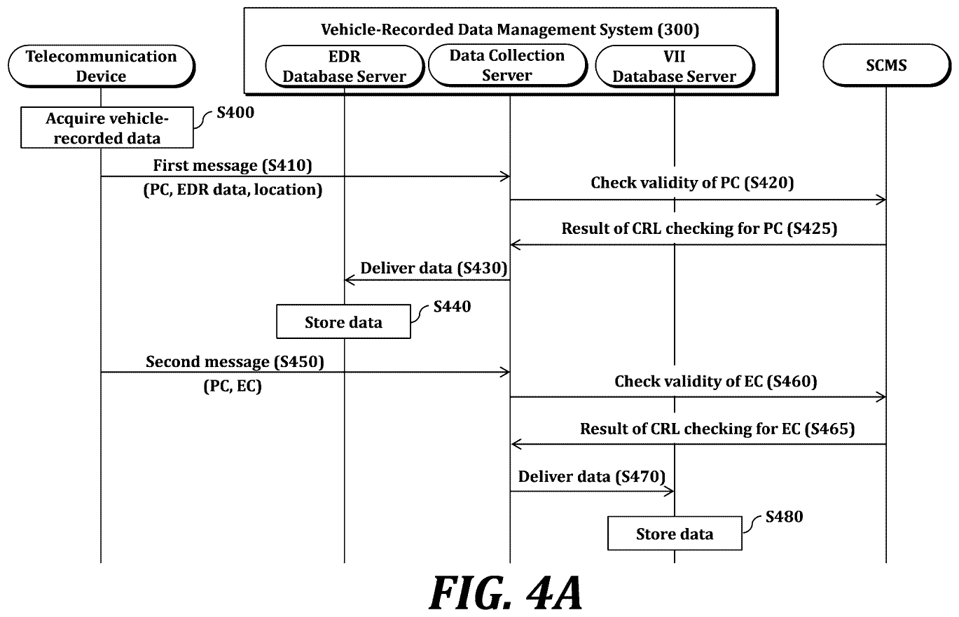

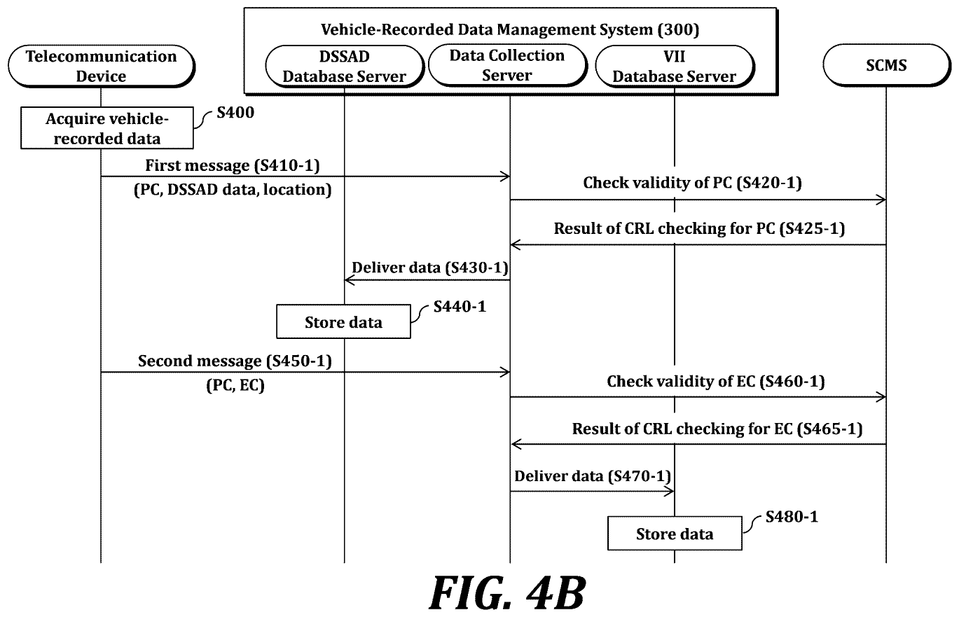

The data collection server 35 may receive, from the telecommunication device 15 of the vehicle, a first message containing vehicle-recorded data and a short-term certificate and a second message containing a long-term certificate and a short-term certificate over a communication network. The vehicle-recorded data may be event data or interaction data or both. The data collection server 35 may receive the vehicle-recorded data, the short-term certificate, and the long-term certificate all at once (e.g., by using a single message) from the telecommunication device 15 of the vehicle. The data collection server 35 may be configured to deliver the vehicle-recorded data and the short-term certificate to the EDR database server 22 or the DSSAD database server 27. For example, when the vehicle-recorded data is the event data, the data collection server 35 delivers the vehicle-recorded data and the short-term certificate to the EDR database server 22. When the vehicle-recorded data is the interaction data, the data collection server 35 delivers the vehicle-recorded data and the short-term certificate to the DSSAD database server 27. The data collection server 35 may be further configured to deliver the long-term certificate and the short-term certificate to the VII database server 32. That is, the data collection server 35 may perform a message routing function or a message filtering function. Operation of the entire system of FIG. 3 including the data collection server 35 will be described in detail later with reference to FIG. 4.

In the vehicle-recorded data management system 300 illustrated in FIG. 3, the servers 22, 27, 32, and 35 may be managed by one operator. The data collection server 35 may be connected to the EDR database server 22, the DSSAD database server 27 and the VII database server 32 via an intranet. In this case, the data collection server 35 may further perform a firewall function to protect the internal network from external networks. Alternatively, the servers 22, 27, 32, and 35 may be managed by different operators.

FIG. 4A is a flowchart illustrating an event data collection process of the system shown in FIG. 3. FIG. 4B is a flowchart illustrating an interaction data collection process of the system shown in FIG. 3.

First, the vehicle telecommunication device 15 acquires vehicle-recorded data from one or more modules, components, and programs including the EDR 11 and the DSSAD 12 (S400). For example, the telecommunication device 15 may receive event data recorded before and after an event from the EDR 11 and collect information on the geographical location, date, and time of the event, an involved vehicle model, etc.

The telecommunication device 15 wirelessly transmits a first message containing the vehicle-recorded data and a short-term certificate PC to the data collection server 35 over a network (S410, S410-1). The vehicle-recorded data may be event data or interaction data or both. As mentioned above, the first message may further contain a geographic location related with event data or interaction data. In addition, the first message may further contain an electronic signature to be verified with a public key related to the short-term certificate PC. The electronic signature may be generated for the vehicle-recorded data and the geographical location using a private key related to the short-term certificate PC.

Upon receiving the first message, the data collection server 35 may query the SCMS 40 for the CRL and check the validity of the short-term certificate PC (S420 to S425, S420-1 to S425-1). When the short-term certificate PC is valid, the data collection server 35 delivers the event data, the short-term certificate PC, and the like contained in the first message to the EDR database server 22 (S430, S430-1). In some embodiments, operations S420 to S425, S420-1 to S425-1 for verifying the validity of the short-term certificate PC may be skipped.

The event data server 22 anonymizes the event data and inputs the same into the event database 21 (S440). For example, the EDR database server 22 may associate the event data and the geographical location with the short-term certificate PC of a corresponding vehicle or the pseudonym extracted from the short-term certificate and store the same in the event database 21. In similarly, the DSSAD data server 27 anonymizes the interaction data and inputs the same into the interaction database 26 (S440-1). For example, the DSSAD database server 22 may associate the interaction data and the geographical location with the short-term certificate PC of a corresponding vehicle or the pseudonym extracted from the short-term certificate and store the same in the interaction database 21.

The telecommunication device 15 transmits a second message containing a long-term certificate EC and the short-term certificate PC used for the first message to the data collection server 35 on the network (S450, S450-1). The second message may further contain an electronic signature to be verified with a public key related to the long-term certificate EC.

Upon receiving the first message, the data collection server 35 may check the validity of the long-term certificate by querying the SCMS 40 for the CRL (S460 to S465, S460-1 to S465-1). When the long-term certificate EC is valid, the data collection server 35 delivers the long-term certificate EC and the short-term certificate PC contained in the second message to the VII database server 32 (S470, S470-1).

The VII database server 32 associates the short-term certificate with the long-term certificate and stores the same in the VII database 31 (S480, S480-1).

Unlike the examples illustrated in FIG. 4A and FIG. 4B, the telecommunication device 15 may transmit the second message containing the short-term certificate and the long-term certificate before transmitting the first message containing the vehicle-recorded data and the short-term certificate. The event data, the short-term certificate, and the long-term certificates may be transmitted all at once (e.g., by a single message).

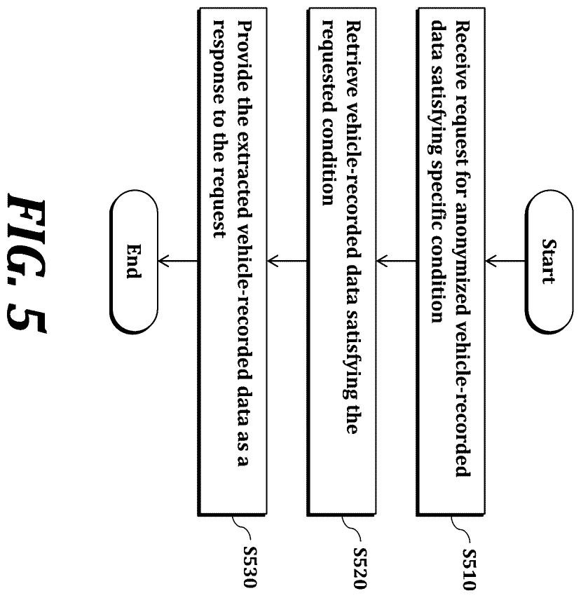

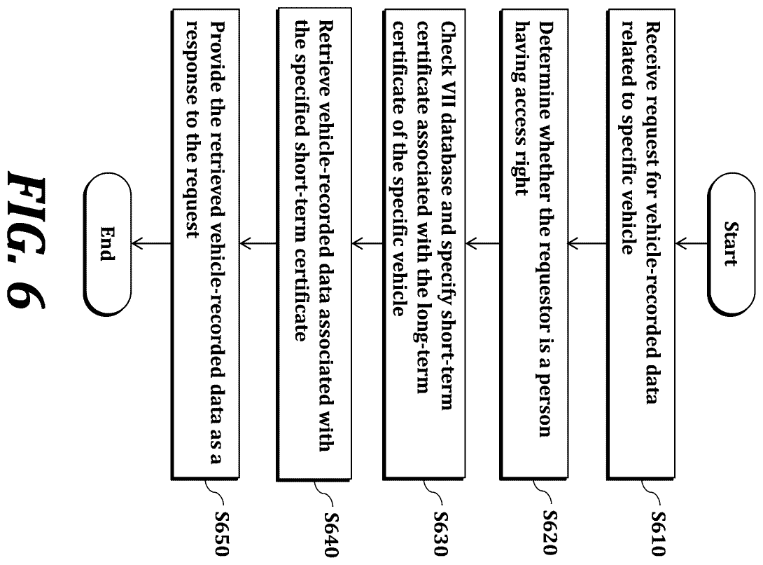

As described above, the third party 50 may perform a query operation on the operator(s) of the vehicle-recorded data management system 100, 300 by specifying a plurality of parameters in order to obtain desired vehicle-recorded data. The query parameters may include at least one parameter related to an investigation range or criterion, such as an event/interaction location, an event/interaction date, an event/interaction time, the model of a vehicle involved, and a VIN. Hereinafter, a process of providing related vehicle-recorded data (e.g., event data or interaction data) by the system 100, 300 illustrated in FIG. 1 or FIG. 3 in response to such a query will be described with reference to FIG. 5 and FIG. 6.

FIG. 5 is a flowchart illustrating a process of providing anonymized vehicle-recorded data by the vehicle-recorded data management system 100, 300 illustrated in FIG. 1 or FIG. 3.

For example, the vehicle-recorded data management system 100, 300 may receive a request for anonymized vehicle-recorded data (e.g., event data or interaction data or both) that satisfies a specific condition, such as events/interactions that occurred in a specific area for a certain period of time, from government agency investigators or researchers (S510). The vehicle-recorded data management system 100, 300 may check the event database 21 or the interaction database 26 and extract a set of one or more event data or interaction data satisfying the requested condition (S520). The vehicle-recorded data management system 100, 300 may provide the extracted set of one or more event data or interaction data as a response to the request (S530). Since the set of event data extracted from the event database 21 and the interaction database 26 are data anonymized with pseudonym certificates (or pseudonyms extracted therefrom) and the set of interaction data extracted from the interaction database 26 are data anonymized with pseudonym certificates (or pseudonyms extracted therefrom), the privacy of the vehicle owner (or driver) is not compromised. Moreover, the VII database 31 is not involved in providing the anonymized event data and the anonymized interaction data. The vehicle-recorded data management system 100, 300 may determine whether the requestor has an access right before or after operation S510.

FIG. 6 is a flowchart illustrating a process of providing vehicle-recorded data related to a specific vehicle by the vehicle-recorded data management system 100, 300 illustrated in FIG. 1 or FIG. 3.

For example, the vehicle-recorded data management system 100, 300 may receive a request for vehicle-recorded data (e.g., event data or interaction data or both) related to a specific VIN from a vehicle owner, an insurance company, or an investigator of an investigative agency (S610). The vehicle-recorded data management system 100, 300 may determine whether the requestor is a person having access right authorized by a court order, a search warrant and/or other applicable laws and regulations or by a relevant vehicle owner (S620). The vehicle-recorded data management system 100, 300 may retrieve the VII database 31 for a long-term certificate corresponding to (assigned to) the VIN and specify a short-term certificate (or pseudonym extracted therefrom) associated with the long-term certificate (S630). Then, the vehicle-recorded data management system 100 may retrieve the event database 21 or the interaction database 26 and extract event data or interaction data corresponding to the specified pseudonym certificate (or pseudonym) (S640). The vehicle-recorded data management system 100, 300 may provide the extracted event data or interaction data as a response to the request (S650). If the VII database 31 is operated by an operator different from those of the event database 21 and the interaction database 26, the short-term certificate (or pseudonym extracted therefrom) obtained by checking the VII database 31 in operation S630 may be provided to the above-mentioned investigators or directly to operators of the event database 21 and the interaction database 26 for use in retrieve the event database 21 and the interaction database 33.

It should be understood that the example embodiments described above may be implemented in many different ways. In some examples, the various methods, apparatuses, servers, and (sub)systems described in this disclosure may be implemented by at least one general purpose computer having a processor, a memory, a disk or other mass storage, a communication interface, input/output (I/O) devices, and other peripherals. The general purpose computer may function as an apparatus to execute the methods described above by loading software instructions into the processor and then executing the instructions to perform the functions described in this disclosure.

The various methods described in this disclosure may be implemented with instructions stored on a non-transitory recording medium that can be read and executed by one or more processors. Non-transitory recording media include, for example, all types of recording devices in which data is stored in a form readable by a computer system. For example, the non-transitory recording media may include storage media such as an erasable programmable read only memory (EPROM), an electrically erasable programmable read-only memory (EPROM), a flash drive, an optical drive, a magnetic hard drive, and a solid state drive (SSD).

Although exemplary embodiments have been described for illustrative purposes, those skilled in the art will appreciate that and various modifications and changes are possible, without departing from the idea and scope of the embodiments. Exemplary embodiments have been described for the sake of brevity and clarity. Accordingly, one of ordinary skill would understand that the scope of the embodiments is not limited by the explicitly described above embodiments but is inclusive of the claims and equivalents thereto.

1. A method performed by a vehicle, the method comprising:
transmitting a first message containing a first certificate and vehicle-recorded data to a first database server associated with a first database so as to store the vehicle-recorded data anonymously in the first database, wherein the first certificate is one of a plurality of short-term certificates assigned to the vehicle to enable an anonymization of the vehicle; and
transmitting a second message containing the first certificate and a second certificate to a second database server associated with a second database so as to store an association of the first certificate with the vehicle in the second database, wherein the second certificate is a long-term certificate assigned to the vehicle and enables an identification of the vehicle.

2. The method of claim 1, wherein the first message further contains an electronic signature to be verified with a public key related to the first certificate.

3. The method of claim 1, wherein the second message further contains an electronic signature to be verified with a public key related to the second certificate.

4. The method of claim 1, wherein the first message further contains a geographical location at which the vehicle records the vehicle-recorded data.

5. The method of claim 1, wherein the vehicle-recorded data includes event data having been recorded by an event data recorder equipped in the vehicle.

6. The method of claim 1, wherein the vehicle-recorded data includes interaction data representing timestamped interactions that have occurred between an autonomous driving system of the vehicle and a driver of the vehicle.

7. The method of claim 1, wherein the first database server and the second database server are under managed by different operators.

8. The method of claim 7, wherein the first database server is managed by a vehicle manufacturer, and the second server is managed by a service provider different from the vehicle manufacturer.

9. A telecommunication device equipped in a vehicle, the device comprising:
one or more processors;
non-transitory memory operatively coupled to the one or more processors, the memory storing instructions to be executed by the one or more processors; and
a wireless transceiver configured to communicate wirelessly via at least one communication network,
wherein the processor, when executing the instructions, is configured to:
cause the transceiver to transmit a first message containing a first certificate and vehicle-recorded data to a first database server associated with a first database so as to store the vehicle-recorded data anonymously in the first database, wherein the first certificate is one of a plurality of short-term certificates assigned to the vehicle and enables an anonymization of the vehicle; and
cause the transceiver to transmit a second message containing the first certificate and a second certificate to a second database server associated with a second database so as to store an association of the first certificate with the vehicle in the second database, wherein the second certificate is a long-term certificate assigned to the vehicle and enables an identification of the vehicle.

10. The device of claim 9, wherein the first message further contains an electronic signature to be verified with a public key related to the first certificate.

11. The device of claim 9, wherein the second message further contains an electronic signature to be verified with a public key related to the second certificate.

12. The device of claim 9, wherein the first message further contains a geographical location at which the vehicle records the vehicle-recorded data.

13. The device of claim 9, wherein the vehicle-recorded data includes event data having been recorded by an event data recorder equipped in the vehicle.

14. The device of claim 9, wherein the vehicle-recorded data includes interaction data representing timestamped interactions that have occurred between an autonomous driving system of the vehicle and a driver of the vehicle.

15. The device of claim 9, wherein the first database server and the second database server are under managed by different operators.

16. The device of claim 15, wherein the first database server is managed by a vehicle manufacturer, and the second server is managed by a service provider different from the vehicle manufacturer.

17. A non-transitory computer-readable medium storing computer-readable instructions for a telecommunication device equipped in a vehicle, wherein the computer-readable instructions, when executed by a processor of the telecommunication device, cause the telecommunication device to:
transmit a first message containing a first certificate and vehicle-recorded data to a first database server associated with a first database so as to store the vehicle-recorded data anonymously in the first database, wherein the first certificate is one of a plurality of short-term certificates assigned to the vehicle and enables an anonymization of the vehicle; and
transmit a second message containing the first certificate and a second certificate to a second database server associated with a second database so as to store an association of the first certificate with the vehicle in the second database, wherein the second certificate is a long-term certificate assigned to the vehicle and enables an identification of the vehicle.

18. The non-transitory computer-readable medium of claim 17, wherein the first message further contains an electronic signature to be verified with a public key related to the first certificate.

19. The non-transitory computer-readable medium of claim 17, wherein the second message further contains an electronic signature to be verified with a public key related to the second certificate.

20. The non-transitory computer-readable medium of claim 17, wherein the first database server is managed by a vehicle manufacturer, and the second server is managed by a service provider different from the vehicle manufacturer.
